(19) United States
(12) Patent Application Publication
(10) Pub. No.: US 2016/0018295 A1
(43) Pub. Date: Jan. 21, 2016

(54) SAMPLING DEVICE

(71) Applicant: Carestream Health, Inc., Rochester, NY (US)

(72) Inventors: David R. Whitcomb, Woodbury, MN (US); Jeffrey Blinn, Maplewood, MN (US)

(21) Appl. No.: 14/742,748

(22) Filed: Jun. 18, 2015

Related U.S. Application Data
(60) Provisional application No. 62/025,114, filed on Jul. 16, 2014.

(51) Int. Cl. G01N 1/10

(52) U.S. Cl. CPC G01N 1/10

(57) ABSTRACT

A device comprising a sampling container comprising a hollow elongated structure formed by at least one sidewall, a first end being open to receive an instrument, and a second end being open to provide a fluid passageway for fluid from a reservoir to enter into or drain from the fluid passageway when the first end of the sampling container is inserted into the fluid in the reservoir, the first end and the second end being disposed at opposite ends of the hollow elongated structure, a sidearm attached to the at least one sidewall, the sidearm comprising a joint, and a valve disposed at the joint.

### CROSS REFERENCE TO RELATED APPLICATIONS

This application claims the benefit of U.S. Provisional Application No. 62/025,114, filed Jul. 16, 2015, entitled “SAMPLING DEVICE,” which is hereby incorporated by reference in its entirety.

### BACKGROUND

During a chemical production process, samples may be collected to understand the production process, monitor the progress of a reaction, control reaction conditions, or evaluate the characteristics of the samples. Sampling devices of various constructions and methods of use may be employed to obtain a sample. See, for example, U.S. Pat. No. 553,044 to Sharples, U.S. Pat. No. 804,894 to Soderlund, U.S. Pat. No. 3,607,100 to Croom, U.S. Pat. No. 2,930,238 to Kellett, and U.S. Pat. No. 2,994,349 to Demos, U.S. Pat. No. 4,054,061 to Valt, U.S. Pat. No. 2,079,344 to Geyer, U.S. Pat. No. 658,250 to Erfmann, U.S. Pat. No. 3,323,874 to Phillips, U.S. Pat. No. 1,973,755 to Geyer, U.S. Pat. No. 1,382,600 to Schreiner, U.S. Pat. No. 2,869,078 to Coulter et al., U.S. Pat. No. 3,361,965 to Coulter et al., U.S. Pat. No. 83,024 to Barbarin, U.S. Pat. No. 317,074 to Baloche et al., U.S. Pat. No. 209,904 to Lapham, U.S. Pat. No. 300,328 to Ryan, U.S. Pat. No. 4,006,062 to Bhuchar et al., U.S. Pat. No. 3,989,169 to Bigley et al., U.S. Pat. No. 1,973,754 to Geyer, and U.S. Pat. No. 8,701,506 to Morris.

Some chemical production processes may require conditions (e.g. temperature, pressure, or non-aqueous environment, etc.) that are incompatible with the operating conditions of a sampling instrument or probe or that may pose as an environmental or safety hazard. Sampling devices intended to handle hazardous or unstable samples or samples requiring conditions outside the operating range of an instrument are available. See, for example, U.S. Pat. No. 2,932,974 to Kaspaul, Chinese Utility Model No. 202033216U, and U.S. Pat. No. 4,726,238 to Reese et al.

### SUMMARY

In some embodiments, a sampling device may comprise a sampling container, a sidearm, and a valve. The sampling container may comprise a hollow elongated structure formed by at least one sidewall, a first end of the sampling container being open to receive an instrument, and a second end being open to provide a fluid passageway for fluid from a reservoir to enter into or drain from the fluid passageway when the first end of the sampling container is inserted into the fluid in the reservoir. The first end and the second end of the sampling container may be disposed at opposite ends of the hollow elongated structure. The sidearm may be attached to the at least one sidewall. The sidearm may comprise a joint and a plurality of side arm sections connected to the joint. The plurality of side arm sections may comprise a first side arm section having a first end connected to the at least one sidewall and a second end connected to the joint, a second side arm section having a first end connected to the joint and a second end connected to the reservoir, and a third side arm section having a first end connected to the joint and a second open, free end for relieving pressure from either the device, the reservoir, or both. The valve may be disposed at the joint. The valve may be capable of being positioned into at least a first valve position and a second valve position. The first valve position may provide a pressure relief passageway between the first side arm section and the third side arm section through the valve for relieving pressure from the sampling container out of the second open, free end of the third side arm section and causing fluid from the reservoir to enter into the fluid passageway from the first end of the sampling container. The second valve position may provide a pressure communication passageway between the first side arm section and the second side arm section for allowing pressure between the sampling container and the reservoir to equalize and causing fluid from the fluid passageway to drain into the reservoir.

In some embodiments, the sampling device may comprise a reservoir, where the second end of the sampling container and the second end of the second side arm section may be connected with the reservoir. In some embodiments, the sampling device may comprise an instrument connected to the sampling container. In some embodiments, the sampling device may comprise threads that are disposed on the hollow elongated structure near the first end of the sampling container for mating with threads disposed on an instrument. In some embodiments, the valve may comprise a stopcock. In some embodiments, the valve may comprise a three-way stop cock.

In some embodiments, a method may involve the use of a device which comprises a tube, a sidearm connected to the tube, a valve disposed on the sidearm, a reservoir containing a fluid in sealing engagement with the tube and the sidearm, and a sampling instrument in sealing engagement with the tube. Such a method may comprise positioning the valve to a first valve position to provide a first passageway between the tube and the sidearm through the valve. After positioning the valve to the first valve position, the tube may exhibit a first tube pressure and the reservoir may exhibit a first reservoir pressure. The first tube pressure may be less than the first reservoir pressure to cause fluid from the reservoir to flow into the tube.

In some embodiments, positioning the valve from the first valve position to a second valve position may provide a second passageway between the tube and the reservoir through the valve. After positioning the valve from the first valve position to the second valve position, the tube may exhibit a second tube pressure and the reservoir may exhibit a second reservoir pressure. The second tube pressure may be greater than or substantially equal to the second reservoir pressure to cause fluid from the tube to drain into the reservoir.

In some embodiments, the valve may comprise a stop cock. In some embodiments, the valve may comprise a three-way stop cock.

### DESCRIPTION OF FIGURES

FIG. 1 shows a schematic of an exemplary embodiment of a sampling device.

FIG. 2A shows a perspective side view of an exemplary embodiment of a sampling device with the side arm pointing toward the left.

FIG. 2B shows a perspective side view of an exemplary embodiment of a sampling device with the side arm pointing toward the right.

FIG. 3 shows a perspective side view of a joint in a side arm of an exemplary embodiment of a sampling device.

FIG. 4 shows an exemplary embodiment of a three-way stop cock.

FIGS. 5A-5D show fluid flow through the plurality of side arm sections of a sampling apparatus in the position as shown in FIG. 2B when the handle of the valve 160 is pointed up toward the first end 124a of the sampling container 120, to the left toward the first end 150a of the third side arm section 148, down toward the second end 124b of the sampling container 120, and to the right toward the free or open end 154b of first side arm section 144, respectively.

### DESCRIPTION

All publications, patents, and patent documents referred to in this document are incorporated by reference herein in their entirety, as though individually incorporated by reference.

U.S. Provisional Application No. 62/025,114, filed Jul. 16, 2015, entitled “SAMPLING DEVICE,” which is hereby incorporated by reference in its entirety.

The preparation of conductive structures (e.g. silver nanowires) may require conditions (e.g. temperature, pressure, non-aqueous environment) that may be incompatible with a sampling instrument or probe (e.g. pH probe). For example, the preparation of silver nanowires may involve polyol solvents and reaction temperatures of between about 100 and 200 degrees Celsius for extended periods of time.

In some cases, it may be desirable to monitor the pH of a reaction, such as, for example, silver nanowire synthesis through a polyol process. The pH probe operates based on a pH measuring circuit that comprises a reference electrode and a measuring electrode, both of which are immersed in the sample in which the pH is to be measured. A pH measurement is a potentiometric measurement, that is, a measurement of an electrical potential. The reference electrode is intended to provide a constant potential regardless of the composition of the solution it is placed in, and the measuring electrode measures the pH of the solution. Some pH probes may be limited to operating at temperatures below the boiling point of water (e.g. 99.97 degrees Celsius at a pressure of 1 atmosphere), operate at temperatures up to about 130 degrees Celsius for a short period of time, or its reference electrode may require a water based electrolyte solution.

Applicant has constructed a sampling device and a method of using the sampling device for isolating a sample that may be subjected to conditions incompatible with a sampling instrument or probe or may pose as an environmental or safety hazard. The sampling device may, for example, be used to sample high temperature processes, such as those used to prepare of silver nanowires in polyols, or, more generally, to extract any sample that may be contained environment for any of a variety of reasons (e.g. to prevent splashes or spillage, to prevent a user or environment from exposure to the reaction, to prevent disruption of the reaction by exposure to ambient conditions), to allow a sample of the reaction to cool, to lower the pressure of a sample taken from a high-pressure reaction vessel, to reduce material waste, etc. In an exemplary embodiment, the sampling device comprises a valve that can produce pressure differentials between the sampling device and reaction vessel to draw fluid from the reaction vessel into the sampling device and/or drain the fluid from the sampling device back into the reaction vessel. In an exemplary embodiment, the sampling device may be airtight or hermetically sealed when assembled with the reaction vessel and sampling instrument to produce the desired pressure differentials.

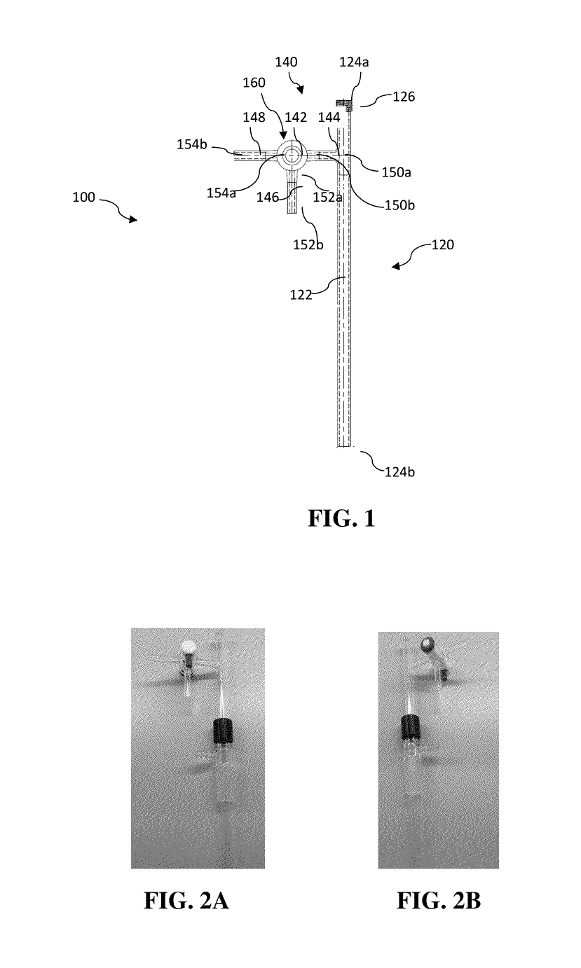

FIG. 1 shows a schematic of an exemplary embodiment of a sampling device 100. FIG. 2A shows a perspective side view of an exemplary embodiment of a sampling device 100 with the side arm pointing toward the left. FIG. 2B shows a perspective side view of an exemplary embodiment of a sampling device 100 with the side arm pointing toward the right. The sampling device 100 comprises a sampling container 120, a side arm 140 attached to the tube, and a valve 160 disposed on the sidearm 140.

The sampling container 120 comprises a body 122 in the form of a hollow elongated structure defined by at least one sidewall and opposing first end 124a and second end 124b disposed at opposite ends of the body or sidewall of the sampling container 120. The sampling container 120 may be a tube comprising a body in the form of a hollow elongated cylinder defined by a tubular sidewall. It should be noted that the sampling container 120 may have other shapes or structures. The first end 124a may receive a sampling probe or instrument (e.g. pH probe) and comprises threads 126 for attaching with the sampling probe or instrument. The attachment between the sampling container 120 and the sampling probe or instrument (e.g. pH probe) may be air tight (e.g. vacuum tight, hermetically sealed, etc.). Adapters other than threads may be used to render the sampling probe or instrument compatible for mating attachment with the sampling container 120. The second end 124b may be inserted into a reservoir, such as a reaction vessel, containing fluid from which a sample may be taken. An adapter may be fitted onto the body of the sampling container to render the sampling container compatible for mating attachment with the reaction vessel. The adapter may provide air tight (e.g. hermetically sealed, vacuum tight, etc.) attachment between the sampling container 120 and the reservoir (e.g. reaction vessel). As shown in FIGS. 2A and 2B, the adapter may comprise a Chem-Thread cap, o-ring, and a tapered glass fitting, which are available through Chemglass Life Sciences (Vineland, N.J.). The second end 124b of the sampling container 120 may be inserted into an opening of the Chem-Thread cap, o-ring, and tapered glass fitting. The o-ring helps keeps the adapter stationary on the sampling container 120 when the Chem-Thread cap and tapered glass fitting are screwed together.

The side arm 140 is attached to the body or sidewall (e.g. cylinder body or structure or tubular sidewall) of the sampling container 120. The side arm 140 comprises a joint 142 at which a plurality of side arm sections 144, 146, and 148 may be connected. Each of the plurality of side arm sections 144, 146, and 148 may have a tubular structure (e.g. tube comprising a body in the form of a hollow elongated cylinder defined by a tubular sidewall). It should be noted that the plurality of side arm sections 144, 146, and 148 may have other shapes or structures, and each of the plurality of side arm sections 144, 146, and 148 may have the same or different structure. As shown, the plurality of side arm sections may comprise a first side arm section 144, a second side arm section 146, and a third side arm section 148. The first side arm section 144 has a first end 150a connected to the body or sidewall of the sampling container 120 and a second end 150b connected to the joint 142. The second side arm section 146 has a first end 152a connected to the joint 142 and a second end 152b that may be connected to the reservoir (not shown), such as a reaction vessel, via a connection element (not shown), such as tubing. The third side arm section 148 has a first end 154a connected to the joint 142 and a free or open end 154b that is not connected to the sampling device 100. The free or open end 154b may be open to the atmosphere or contents exiting from the free or open end 154b may be received by a container that may or may not be attached to the free or open end 154b. It is should be noted that the side arm may have any number of side arm sections (first side arm section, second side arm section, third side arm section, etc.).

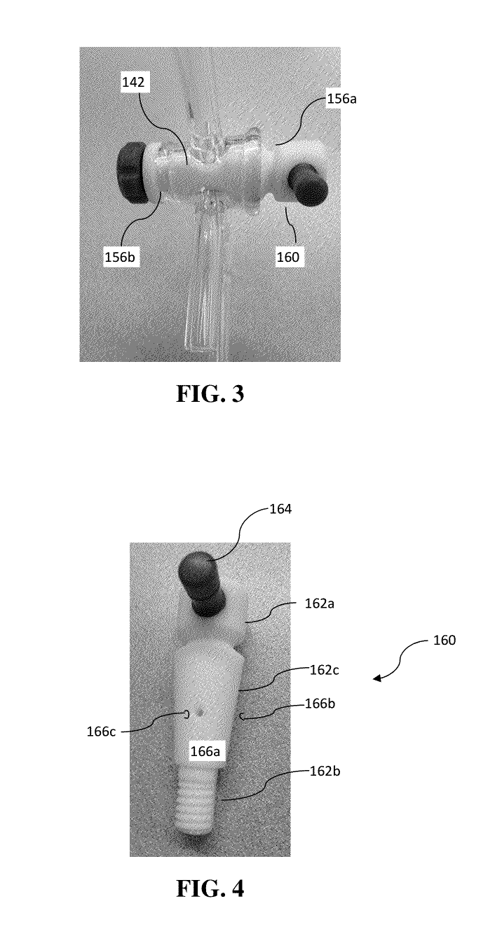

As shown in FIG. 3, the joint 142 comprises a body in the form of a hollow structure defined by at least one sidewall and opposing first end 156a and second end 156b disposed at opposite ends of the body or sidewall of the joint 142. The joint 142 may be in the shape of a hollow conical frustum (e.g. clipped cone, tapered cylinder) structure defined by a tapered sidewall, such that one (e.g. first end 156a) of the opposing ends may have a larger circumference than the other end (e.g. second end 156b). It should be noted that the joint 142 may have other shapes or structures. The joint 142 is adapted to contain or support the valve 160 on the sidearm 140. The joint 142 may conform or correspond to the shape of the valve 160 for a tight fit between the joint 142 and the valve 160 when the valve 160 is inserted into the joint 142. Either or both of the opposing first end 156a and second end 156b may be open to receive the valve 160. In exemplary embodiments, both opposing first end 156a and second end 156b are open, the first end 156a for receiving the valve 160 and the second end 156b for allowing the valve 160 to protrude through the second end 156b so other mechanical components may be connected with the protruded part of the valve 160 to secure the valve 160 within the joint 142.

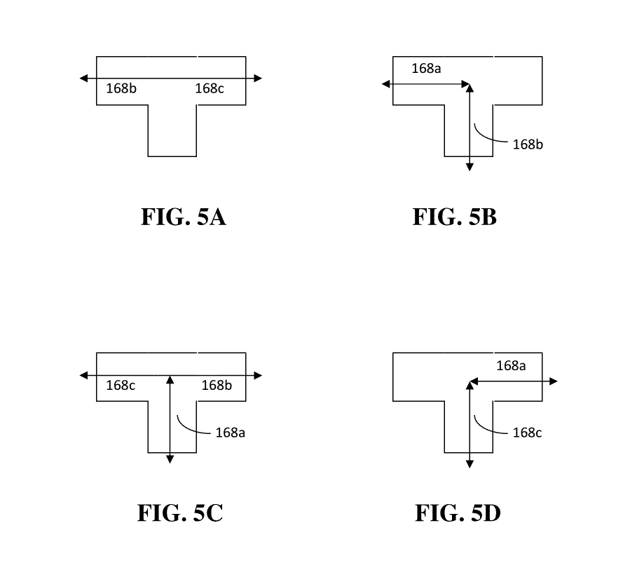

In exemplary embodiments, the valve 160 is a stop cock, particularly a three-way stop cock, as shown in FIG. 4. It is noted that the sampling device 100 may comprise a different valve than the three-way stop cock. The valve 160 comprises a body having opposing first end portion 162a and second end portion 162b disposed at opposite ends of an intermediate portion 162c. The first end portion 162a comprises a handle 164. The intermediate portion 162c has a conical frustum shape (e.g. clipped cone, tapered cylinder) although it may have other shapes and structures. The intermediate portion has a first opening 166a, second opening 166b, and third opening 166c that extend into the body and form first, second, and third passages 168a, 168b, and 168c within the body, respectively, depicted in FIGS. 5A-5D. The first opening 166a is positioned in a first position that is aligned with the handle 164, such that the first passage 168a extending from the first opening 166a into the body is aligned with a plane that is substantially parallel to the plane upon which the longitudinal dimension of the handle 164 lies. The second opening 166b is positioned in a second position that is about 90 degrees from the first opening 166a, such that the second passage 168b extending from the second opening 166b into the body is substantially perpendicular to the first passage 168a. The third opening 166c is positioned in a third position that is about 180 degrees from the second position (e.g. 90 degrees from the first position opposite from the second position), such that the third passage 168c extending from the third opening 166c into the body is substantially perpendicular to the first passage 168a (e.g. about 180 degrees from the second passage 168b).

In an exemplary embodiment, the sampling apparatus 100 is air tight (e.g. vacuum tight, hermetically sealed, etc.) with the first end 124a of its sampling container 120 in air tight (e.g. vacuum tight, hermetically sealed, etc.) engagement with a sampling probe or instrument (e.g. pH probe) and the second end 154b of third side arm section 148 of its side arm 140 and the second end 124b of its sampling container 120 each in airtight (e.g. vacuum tight, hermetically sealed, etc.) engagement with a reservoir (e.g. reaction vessel) filled with a reaction product from which a sample may be taken. Fluid flows into or drains from the sampling apparatus 120 based on the difference in pressure (e.g. pressure differential) between the sampling container 120 and the reservoir. The handle 164 of the valve 160 may be rotated into different positions that provide different passages among the sampling container 120, reservoir (e.g. reaction vessel), and the atmosphere. FIGS. 5A-5D show fluid flow through the plurality of side arm sections of a sampling apparatus in the position as shown in FIG. 2B when the handle of the valve 160 is pointed up toward the first end 124a of the sampling container 120, to the left toward the first end 150a of the third side arm section 148, down toward the second end 124b of the sampling container 120, and to the right toward the free or open end 154b of first side arm section 144, respectively.

To draw a sample of the contents in the reservoir (e.g. reaction vessel) into the sampling container 120, the valve 160 can be positioned (e.g. rotated, turned, etc.) into a first valve position using a handle 164. The handle 164 may extend from the first end portion 162a of the valve 160 in a direction opposite from the direction at which the second side arm section 146 extends from the joint 142. The handle 164 may be aligned substantially parallel to the longitudinal dimension of the sampling container 120, substantially parallel to the second side arm section 146, substantially perpendicular to the first side arm section 144 or the third side arm section 148. As shown in FIG. 5A, first passage 168a extends from the body of the valve 160 and into the sidewall of the joint through first opening 166a and second passage 168b and third passage 168c form a first passageway in the first side arm section 144 and the third side arm section 148 between the sampling container 120 and the free or open end 154b through respective second and third openings 166b, 166c. Pressure from the sampling container 120 may vent through the first passageway out of the free or open end 154b, and the pressure in the sampling apparatus 100 may become less than the pressure in the reservoir (e.g. reaction vessel). This pressure differential can cause a sample of the reaction product from the reservoir to flow into the sampling container 120.

To drain a sample from the sampling container 120 back into the reservoir, the valve 160 can be positioned (e.g. rotated, turned, etc.) from the first valve position to a second valve position (e.g. rotation of 90 degrees in a counterclockwise direction from the first valve position) using a handle 164. The handle 164 may extend from the first end portion 162a of the valve 160 in a direction opposite from the direction at which the third side arm section 148 extends from the joint 142. The handle 164 may be aligned substantially perpendicular to the longitudinal dimension of the sampling container 120, substantially perpendicular to the second side arm section 146, substantially parallel to the first side arm section 144 or the third side arm section 148. As shown in FIG. 5B, first passage 168a and second passage 168b form a second passageway in the first side arm section 144 and the second side arm section 146 between the sampling container 120 and the reservoir through respective first and second openings 166a, 166b, and third passage 168c extends from the body of the valve 160 and into the sidewall of the of the joint through third opening 166c. Pressure in the sampling container 120 and the reservoir may become substantially equal. This pressure differential can cause the sample to drain into the reservoir.

FIG. 5C shows all passages 168a, 168b, 168c communicating with each other. In this configuration, the pressure in the sampling container 120 and the pressure in the reservoir may become substantially equal with the environment that the free or open end 154b opens into. FIG. 5D shows a third passageway between the reservoir and free or open end 154b. In this configuration, the pressure in the reservoir may vent through the free or open end 154b, and the pressure in the reservoir may become less than the pressure in the sampling container 120 or the pressure in the reservoir may become substantially equal with the environment into which the free or open end 154b opens into. It should be understood that the sampling apparatus may be assembled with the valve in any of the valve positions prior to operating the sampling apparatus to draw or drain a sample.

### Exemplary Embodiments

U.S. Provisional Application No. 62/025,114, filed Jul. 16, 2015, entitled “SAMPLING DEVICE,” which is hereby incorporated by reference in its entirety, disclosed the following ten exemplary non-limiting embodiments:
A. A device comprising:

a sampling container comprising a hollow elongated structure formed by at least one sidewall, a first end being open to receive an instrument, and a second end being open to provide a fluid passageway for fluid from a reservoir to enter into or drain from the fluid passageway when the first end of the sampling container is inserted into the fluid in the reservoir, the first end and the second end being disposed at opposite ends of the hollow elongated structure,

a sidearm attached to the at least one sidewall, the sidearm comprising a joint and a plurality of side arm sections connected to the joint, the plurality of side arm sections comprising a first side arm section having a first end connected to the at least one sidewall and a second end connected to the joint, a second side arm section having a first end connected to the joint and a second end connected to the reservoir, and a third side arm section having a first end connected to the joint and a second open, free end for relieving pressure from either the device, the reservoir, or both, and

a valve disposed at the joint, the valve being capable of being positioned into at least
a first valve position for providing a pressure relief passageway between the first side arm section and the third side arm section through the valve for relieving pressure from the sampling container out of the second open, free end of the third side arm section and causing fluid from the reservoir to enter into the fluid passageway from the first end of the sampling container, and
a second valve position for providing a pressure communication passageway between the first side arm section and the second side arm section for allowing pressure between the sampling container and the reservoir to equalize and causing fluid from the fluid passageway to drain into the reservoir.
B. The device according to embodiment A, further comprising a reservoir, wherein the second end of the sampling container and the second end of the second side arm section are connected with the reservoir.
C. The device according to either of embodiments A or B, further comprising an instrument connected to the sampling container.
D. The device according to any of embodiments A-C, further comprising threads disposed on the hollow elongated structure near the first end of the sampling container for mating with threads disposed on an instrument.
E. The device according to any of embodiments A-D, wherein the valve comprises a stopcock.
F. The device according to any of embodiments A-E, wherein the valve comprises a three-way stopcock.
G. A method using a device which comprises a tube, a sidearm connected to the tube, a valve disposed on the sidearm, a reservoir containing a fluid in sealing engagement with the tube and the sidearm, and a sampling instrument in sealing engagement with the tube, the method comprising the steps of:

positioning the valve to a first valve position to provide a first passageway between the tube and the sidearm through the valve, wherein, after positioning the valve to the first valve position, the tube exhibits a first tube pressure and the reservoir exhibits a first reservoir pressure, the first tube pressure being less than the first reservoir pressure to cause fluid from the reservoir to flow into the tube.
H. The method according to embodiment G, further comprising

positioning the valve from the first valve position to a second valve position to provide a second passageway between the tube and the reservoir through the valve, wherein, after positioning the valve from the first valve position to the second valve position, the tube exhibits a second tube pressure and the reservoir exhibits a second reservoir pressure, the second tube pressure being greater than or substantially equal to the second reservoir pressure to cause fluid from the tube to drain into the reservoir.
J. The method according to any of embodiments G or H, wherein the valve comprises a stop cock.
K. The method according to any of embodiments G-J, wherein the valve comprises a three-way stop cock.

The invention has been described in detail with reference to specific embodiments, but it will be understood that variations and modifications can be effected within the spirit and scope of the invention. The presently disclosed embodiments are therefore considered in all respects to be illustrative and not restrictive. The scope of the invention is indicated by the attached claims, and all changes that come within the meaning and range of equivalents thereof are intended to be embraced therein.

What is claimed:

1. A device comprising:
a sampling container comprising a hollow elongated structure formed by at least one sidewall, a first end being open to receive an instrument, and a second end being open to provide a fluid passageway for fluid from a reservoir to enter into or drain from the fluid passageway when the first end of the sampling container is inserted into the fluid in the reservoir, the first end and the second end being disposed at opposite ends of the hollow elongated structure,
a sidearm attached to the at least one sidewall, the sidearm comprising a joint and a plurality of side arm sections connected to the joint, the plurality of side arm sections comprising a first side arm section having a first end connected to the at least one sidewall and a second end connected to the joint, a second side arm section having a first end connected to the joint and a second end connected to the reservoir, and a third side arm section having a first end connected to the joint and a second open, free end for relieving pressure from either the device, the reservoir, or both, and
a valve disposed at the joint, the valve being capable of being positioned into at least
a first valve position for providing a pressure relief passageway between the first side arm section and the third side arm section through the valve for relieving pressure from the sampling container out of the second open, free end of the third side arm section and causing fluid from the reservoir to enter into the fluid passageway from the first end of the sampling container, and
a second valve position for providing a pressure communication passageway between the first side arm section and the second side arm section for allowing pressure between the sampling container and the reservoir to equalize and causing fluid from the fluid passageway to drain into the reservoir.

2. The device according to claim 1, further comprising a reservoir, wherein the second end of the sampling container and the second end of the second side arm section are connected with the reservoir.

3. The device according to claim 1, further comprising an instrument connected to the sampling container.

4. The device according to claim 1, further comprising threads disposed on the hollow elongated structure near the first end of the sampling container for mating with threads disposed on an instrument.

5. The device according to claim 1, wherein the valve comprises a stopcock.

6. The device according to claim 1, wherein the valve comprises a three-way stopcock.

7. A method using a device which comprises a tube, a sidearm connected to the tube, a valve disposed on the sidearm, a reservoir containing a fluid in sealing engagement with the tube and the sidearm, and a sampling instrument in sealing engagement with the tube, the method comprising:
positioning the valve to a first valve position to provide a first passageway between the tube and the sidearm through the valve, wherein, after positioning the valve to the first valve position, the tube exhibits a first tube pressure and the reservoir exhibits a first reservoir pressure, the first tube pressure being less than the first reservoir pressure to cause fluid from the reservoir to flow into the tube.

8. The method according to claim 7, further comprising
positioning the valve from the first valve position to a second valve position to provide a second passageway between the tube and the reservoir through the valve, wherein, after positioning the valve from the first valve position to the second valve position, the tube exhibits a second tube pressure and the reservoir exhibits a second reservoir pressure, the second tube pressure being greater than or substantially equal to the second reservoir pressure to cause fluid from the tube to drain into the reservoir.

9. The method according to claim 7, wherein the valve comprises a stop cock.

10. The method according to claim 7, wherein the valve comprises a three-way stop cock.
